(19) United States
(12) Patent Application Publication
(10) Pub. No.: US 2015/0293494 A1
(43) Pub. Date: Oct. 15, 2015

(54) IMAGE FORMING APPARATUS

(71) Applicant: Gakushi TANAKA, Kanagawa (JP)

(72) Inventor: Gakushi TANAKA, Kanagawa (JP)

(73) Assignee: Ricoh Company, Ltd., Tokyo (JP)

(21) Appl. No.: 14/680,449

(22) Filed: Apr. 7, 2015

(30) Foreign Application Priority Data
Apr. 14, 2014 (JP) 2014-083218

(51) Int. Cl. G03G 21/20

(52) U.S. Cl. CPC G03G 21/206

(57) ABSTRACT

An image forming apparatus includes a photoconductor; an exposure device to expose a surface of the photoconductor to form an electrostatic latent image on the photoconductor; a developing device to develop the electrostatic latent image formed on the photoconductor with developer to render the electrostatic latent image visible as a toner image; a transfer device to transfer the toner image onto a recording medium; a fixing device to fix the toner image onto the recording medium; and an evacuation space disposed in an area adjacent to the photoconductor to accommodate the exposure device during detachment and attachment of the photoconductor. The evacuation space serves as a vent duct to circulate air to cool an image forming unit including the photoconductor during printing.

### CROSS-REFERENCE TO RELATED APPLICATION

The present application claims priority pursuant to 35 U.S.C. §119(a) from Japanese patent application number 2014-083218, filed on Apr. 14, 2014, the entire disclosure of which is incorporated by reference herein.

### BACKGROUND

1. Technical Field

Exemplary embodiments of the present invention relate to an image forming apparatus that forms an electrostatic latent image on a photoconductor with an exposure device, develops the electrostatic latent image with toner to form a visible toner image, transfers the toner image on a recording medium, and fixes the image onto the recording medium.

2. Background Art

An image forming apparatus employing electrophotography forms a latent image by exposing a surface of the photoconductor with light from an exposure device including a light-emitting part, and forms a toner image by rendering the electrostatic latent image visible using a developing device. The visible toner image is then transferred onto the recording medium and is fixed thereon, completing image formation.

Recently, there has been keen demand for compact image forming apparatuses. The compact configuration of these apparatuses makes it necessary to prevent cooling efficiency of the compact image forming apparatus from being degraded.

Conventionally, efforts are made to prevent heat from conducting to a toner container of the image forming apparatus. Specifically, a vent duct to circulate air inside the apparatus is disposed such that the exposure device and the toner container sandwich the vent duct from above and from below. Thus, while absorbing the heat from the exposure device, the heat does not conduct to the toner container.

In another approach, the image forming apparatus includes an array of light-emitting parts and a supporter to support the light-emitting parts. With a cartridge including a photoconductor attached to the apparatus body, the exposure device exposes the photoconductor to form an image on the recording medium. The supporter includes an air passage duct extending in the longitudinal direction of the cartridge to cool it when the cartridge is mounted to the apparatus body.

The photoconductor included in the image forming apparatus is a consumable, replaced after a predetermined number of printouts. The photoconductor is included in an image forming unit together with the developing device. In a compact image forming apparatus, the thus-formed photoconductor is replaced when the image forming unit is replaced as a whole.

On the other hand, as a light-emitting device of the exposure device, a light emitting diode (LED) array can be used. The LED array needs to be disposed near the photoconductor during printing. However, because the LED array itself is both costly and durable, the LED array is not a consumable and disposed on a side of the apparatus body not in the image forming unit as a replacement target. The LED array is retracted away from the photoconductor when the image forming unit is replaced as a whole.

### SUMMARY

In one embodiment of the disclosure, there is provided an improved image forming apparatus including a photoconductor; an exposure device to expose a surface of the photoconductor to form an electrostatic latent image on the photoconductor; a developing device to develop the electrostatic latent image formed on the photoconductor with developer to render the electrostatic latent image visible as a toner image; a transfer device to transfer the toner image onto a recording medium; a fixing device to fix the toner image onto the recording medium; and an evacuation space disposed in an area adjacent to the photoconductor to accommodate the exposure device during detachment and attachment of the photoconductor. The evacuation space serves as a vent duct to circulate air to cool an image forming unit including the photoconductor during printing.

These and other objects, features, and advantages of the present invention will become apparent upon consideration of the following description of the preferred embodiments of the present invention when taken in conjunction with the accompanying drawings.

### BRIEF DESCRIPTION OF THE DRAWINGS

FIG. 1 schematically illustrates an image forming apparatus according to a first embodiment of the present invention;

FIG. 2 schematically illustrates a state in which an LED array is retracted in the image forming apparatus;

FIG. 3 is a partial cross-sectional view illustrating the image forming apparatus;

FIG. 4 schematically illustrates a state in which the LED array is retracted in the image forming apparatus; and

FIG. 5 is a partial perspective view of an image forming unit of the image forming apparatus according to a second embodiment of the present invention.

### DETAILED DESCRIPTION

Hereinafter, preferred embodiments for a monochrome printer employing electrophotography according to a first embodiment of the present invention will be described in detail. Exemplary embodiments of the present invention are also applicable to color printers, copiers, facsimile machines, multifunction apparatuses combining any of the above facilities, and various machines as far as they form images.

### First Embodiment

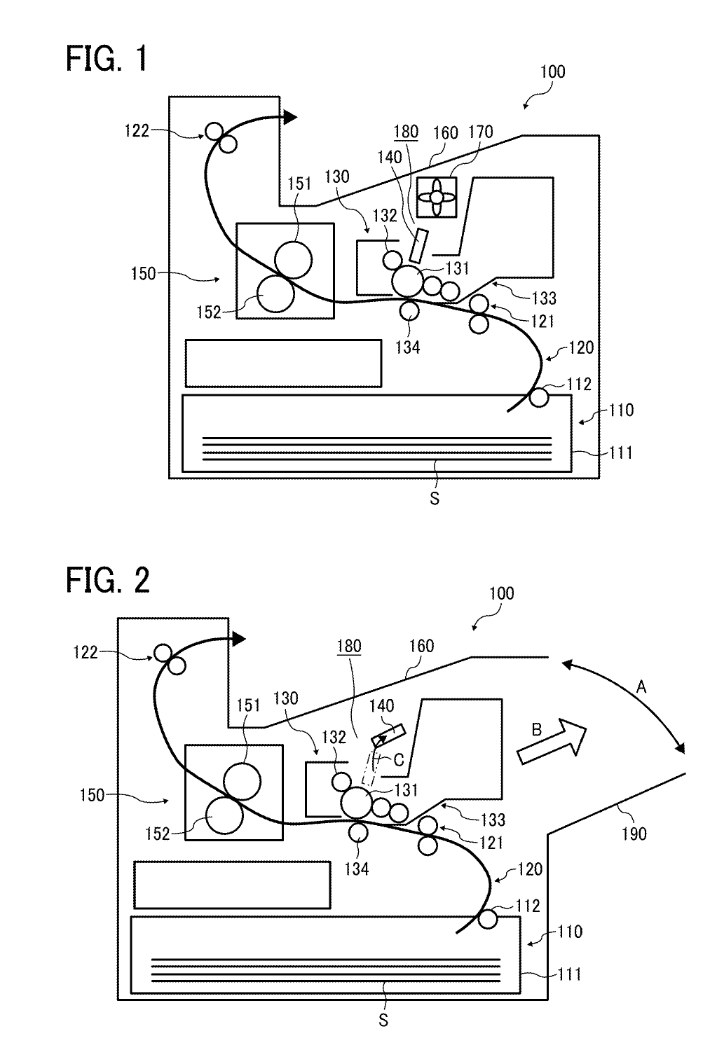

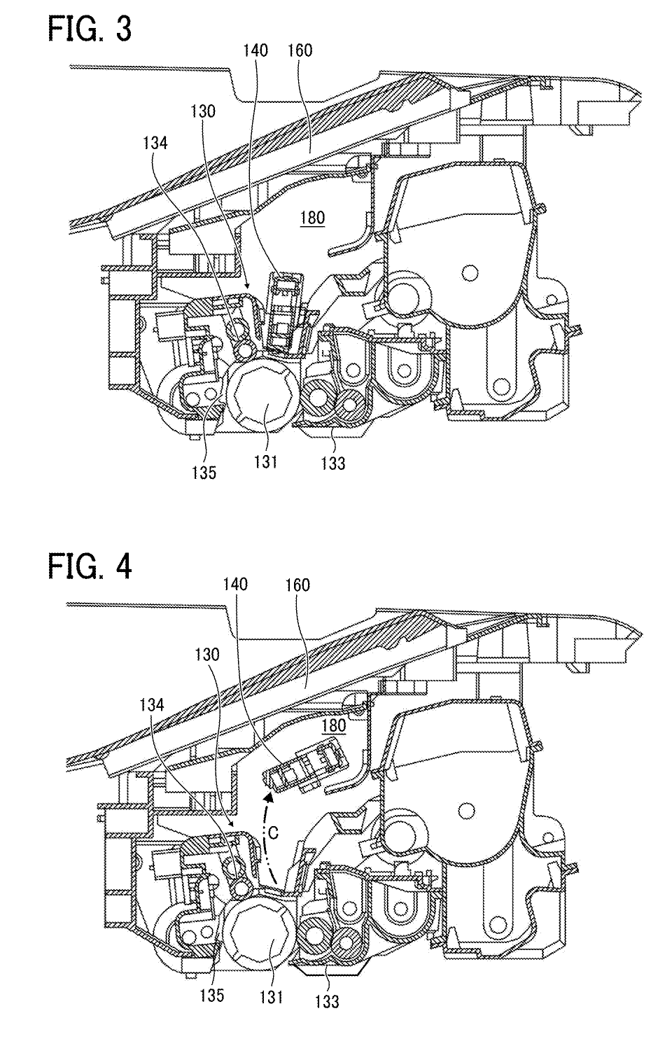

FIG. 1 schematically illustrates an image forming apparatus according to a first embodiment of the present invention. FIG. 2 schematically illustrates a state in which an LED array is retracted in the image forming apparatus. FIG. 3 is a partial cross-sectional view illustrating the image forming apparatus. FIG. 4 schematically illustrates a state in which the LED array is retracted in the image forming apparatus.

As illustrated in FIG. 1, the image forming apparatus 100 according to the first embodiment includes a sheet feed section 110 to store a recording sheet S as a recording medium; a conveyance device 120 to convey the recording sheet S from the sheet feed section 110; an image forming unit 130 to form a toner image on the conveyed recording sheet S; an LED array 140 as an exposure device to emit light beams for exposure toward the image forming unit 130; and a fixing device 150 to fix the toner image formed on the recording sheet S with heat and pressure. A sheet discharge tray 160, on which the recording sheet S carrying the formed image thereon is discharged, is disposed on an upper surface of the image forming apparatus 100. Furthermore, the image forming apparatus 100 includes a photoconductor 131, a developing device 133, and a cooling fan 170 to cool the photoconductor 131 and the developing device 133, because the fixing device 150 is raised to high temperature and the photoconductor 131 and the developing device 133 are heat-sensitive.

The sheet feed section 110 includes a sheet feed tray 111 in which a plurality of recording sheets S is stacked, and a sheet separator 112 to separate and convey a topmost sheet from the plurality of recording sheets S in the sheet feed tray 111.

The conveyance device 120 is constructed of a pair of registration rollers 121 that controls posture and conveyance timing of the recording sheet S, a plurality of conveyance roller pairs, and a pair of sheet discharge rollers 122 to discharge the fixed recording sheet S to the sheet discharge tray 160.

The image forming unit 130 is constructed of the photoconductor 131 on which a latent image is formed by exposure to light from the LED array 140; a charger 132 to uniformly charge a surface of the photoconductor 131; the developing device 133 to develop by adhering toner to the electrostatic latent image on the photoconductor 131 formed by the exposure from the LED array 140; and a cleaner 135 (see FIG. 3) to clean the photoconductor 131 after transfer. The image forming unit 130 thus integrally formed of various parts and components is detachably attachable to the image forming apparatus 100 as a whole unit. When the photoconductor 131 deteriorates with use, the image forming unit 130 is removed from the apparatus and replaced with a new image forming unit. A transfer roller 134 to transfer the developed toner image onto the recording sheet S is disposed below the photoconductor 131. The transfer roller 134 and the photoconductor 131 form a transfer section.

The photoconductor 131 includes a cylindrical shape and is driven to rotate by a drive source. A photosensitive layer is formed on an outer periphery of the photoconductor 131. When the LED array 140 directs light beams onto the outer surface of the photoconductor 131, an electrostatic latent image corresponding to image data is formed on the surface of the photoconductor 131.

The charger 132 uniformly charges the outer peripheral surface of the photoconductor 131 while contacting the surface of the photoconductor 131 (that is, a contact method). The developing device 133 supplies toner as a developing agent to the photoconductor 131 so that the supplied toner adheres to the electrostatic latent image written on the outer peripheral surface of the photoconductor 131. As a result, the electrostatic latent image on the photoconductor 131 is rendered visible as a toner image. The developing device 133 according to the present embodiment does not contact the photoconductor 131.

The cleaner 135 removes residual toner remaining on the outer peripheral surface of the photoconductor 131 with a brush or a blade. The brush removes the toner while contacting the outer peripheral surface of the photoconductor 131. The blade removes the toner while contacting the photoconductor 131.

The LED array 140 including a plurality of LED light emitting elements is disposed along an axial direction of the photoconductor 131. The LED array 140 converts image data input from a personal computer, a word processer, or the like connected to the image forming apparatus 100 into signals for driving the light source, and causes the LED light emitting elements included in the LED array 140 to emit light beams. It is noted that the lifetime of the LED array 140 is longer than that of the photoconductor 131. As a result, the LED array 140 is attached to the image forming apparatus 100, not to the image forming unit 130 to be replaced together with the photoconductor 131. In addition, when the image forming unit 130 is replaced, the LED array 140 is configured to be movable from a position near the photoconductor 131 during image formation to a position away from the image forming unit 130 so as not to interfere with the movement of the image forming unit 130 during replacement. A front cover 190 and the LED array 140 are connected with a known link mechanism, so that the LED array 140 moves in conjunction with the movement of the front cover 190 (in Arrow A direction) that is opened for the replacement of the image forming unit 130 (in Arrow B direction).

The fixing device 150 includes a fixing roller 151 and a heat roller 152 that together form a fixing nip. The recording sheet S is passed through the fixing nip and the toner image is fixed onto the recording sheet S while passing through the fixing nip. A built-in heater, such as a halogen heater, is disposed inside the heat roller 152.

The recording sheet S stacked on the sheet feed tray 111 is conveyed by the conveyance device 120, passes through the pair of registration rollers 121, and reaches the transfer section formed between the photoconductor 131 and the transfer roller 134. The electrostatic latent image is formed on the photoconductor 131 by exposure by the LED array 140, and the electrostatic latent image is developed by the toner supplied from the developing device 133. This toner image is transferred on the recording medium that has reached the transfer section. Then, the recording sheet S on which the toner image has been transferred is conveyed to the fixing device 150, which fuses and fixes the toner image onto the recording sheet S, and the pair of sheet discharge rollers 122 discharges the recording sheet S to the sheet discharge tray 160.

In the thus-configured image forming apparatus 100, when the image forming unit 130 is replaced with a new one, the front cover 190 is opened in a direction indicated by Arrow A in FIG. 2 and the image forming unit 130 is taken out along the direction indicated by Arrow B in FIG. 2. In this case, the LED array 140 disposed on the apparatus body moves to the evacuation space 180 inside the apparatus body in conjunction with the movement of the front cover 190 via a linking mechanism (see Arrow C in FIG. 2). This evacuation space 180 is disposed in an area adjacent to the photoconductor 131, below and at an interior side of the sheet discharge tray 160, and above the image forming unit 130. The evacuation space 180 is disposed along the axial direction of the photoconductor 131 so that the LED array 140 can be installed along the axial direction of the photoconductor 131. Furthermore, the evacuation space 180 includes a sufficient cross-sectional area such that the LED array 140 moves to a position not interfering with the movement of the image forming unit 130 in the replacement.

In the image forming apparatus 100 according to the first embodiment, the evacuation space 180 is configured as a vent duct where air circulates to cool the image forming unit 130 including the photoconductor 131 during the printing operation of the image forming apparatus 100. As a result, external air introduced by the cooling fan 170 flows along the image forming unit 130 and cools the image forming unit 130 including the photoconductor 131 and the developing device 133. The cross-sectional area of the evacuation space 180 allows to move the LED array 140 to the retracted position and to circulate external air enough to cool the image forming apparatus 100. Thus, the image forming apparatus 100 according to the present embodiment maintains good cooling while effectively using the limited space inside the apparatus, achieves to materialize a compact-size apparatus.

Further, because the evacuation space 180 is disposed below the sheet discharge tray 160, while the air passing through the evacuation space 180 cools the image forming unit 130, the recording sheet S heated by the fixing device 150 to be discharged to the sheet discharge tray 160 can be cooled down.

Thus, the evacuation space 180 can be effectively used for the exposure device as a vent duct to circulate air to cool the image forming unit, and while securing the cooling performance, the space inside the apparatus can be effectively used, and a compact image forming apparatus can be realized.

### Second Embodiment

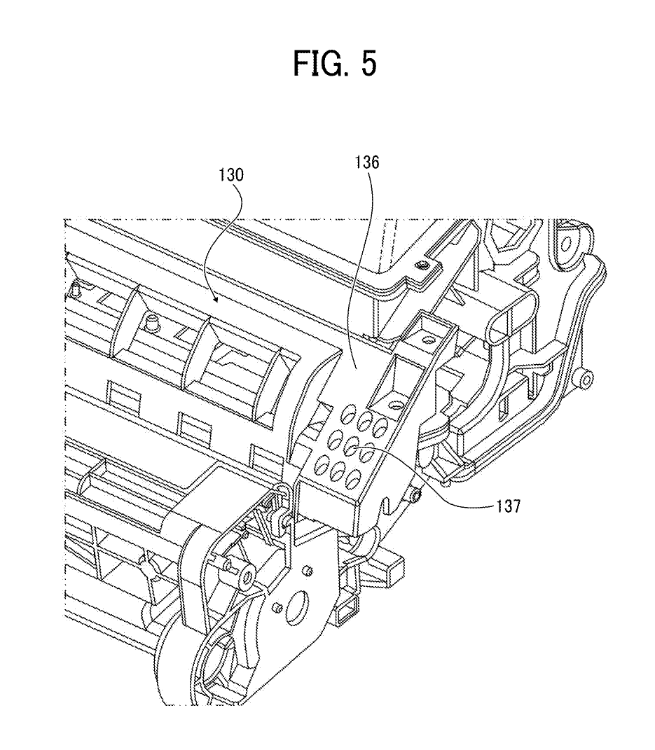

FIG. 5 is a partial perspective view of the image forming unit of the image forming apparatus according to a second embodiment of the present invention. The present image forming apparatus includes nine vent holes 137 disposed on a cover 136 that constructs an external case for the image forming unit 130. The remainder of the image forming apparatus 100 is similar to that of the first embodiment.

According to the second embodiment, the air entering through the vent holes 137 and passing through the evacuation space 180 can be selectively introduced to a portion of the image forming unit 130 that needs to be cooled. With this configuration, the image forming unit 130 can be more effectively cooled.

Additional modifications and variations of the present invention are possible in light of the above teachings. It is therefore to be understood that, within the scope of the appended claims, the invention may be practiced other than as specifically described herein.

What is claimed is:

1. An image forming apparatus comprising:
a photoconductor;
an exposure device to expose a surface of the photoconductor to form an electrostatic latent image on the photoconductor;
a developing device to develop the electrostatic latent image formed on the photoconductor with developer to render the electrostatic latent image visible as a toner image;
a transfer device to transfer the toner image onto a recording medium;
a fixing device to fix the toner image onto the recording medium; and
an evacuation space disposed in an area adjacent to the photoconductor to accommodate the exposure device during detachment and attachment of the photoconductor,
wherein the evacuation space serves as a vent duct to circulate air to cool an image forming unit including the photoconductor during printing.

2. The image forming apparatus as claimed in claim 1, further comprising a cover to cover the image forming unit,
wherein the cover includes vent holes through which air passing through the evacuation space flows into the image forming unit.

3. The image forming apparatus as claimed in claim 1, further comprising a sheet discharge tray on which the recording medium carrying the toner image is discharged, wherein the evacuation space is disposed at an interior side of the sheet discharge tray.
